(19) United States
(12) Patent Application Publication
(10) Pub. No.: US 2025/0298359 A1
(43) Pub. Date: Sep. 25, 2025

(54) IMAGE FORMING APPARATUS

(71) Applicant: CANON KABUSHIKI KAISHA, Tokyo (JP)

(72) Inventor: YUKINOJO TODA, Saitama (JP)

(21) Appl. No.: 19/050,506

(22) Filed: Feb. 11, 2025

(30) Foreign Application Priority Data
Mar. 25, 2024 (JP) 2024-048093

(51) Int. Cl. G03G 15/00; G03G 15/23; H04N 1/00

(52) U.S. Cl. CPC G03G 15/6579; G03G 15/234; G03G 15/6552; H04N 1/00602; H04N 1/00631; H04N 1/00795

(57) ABSTRACT

Disclosed is an image forming apparatus including: an image forming portion for forming an image on a sheet; a re-feeding portion for feeding again the sheet on which an image is formed by the image forming portion to the image forming portion; and a reverse portion for reversing the sheet on which an image is formed by the image forming portion and for conveying the reversed sheet to the re-feeding portion. The reverse portion includes: a reverse roller for conveying the sheet while rotating normally and thereafter conveying the the sheet by reversing the direction of the conveying of the sheet while rotating reversely; a helical gear provided on a shaft of the reverse roller, the helical gear rotating together with the reverse roller to transmit a driving force to the reverse roller; and a pressing member for pressing the reverse roller in an axial direction.

### BACKGROUND OF THE INVENTION

### Field of the Invention

This invention relates to an image forming apparatus that forms an image on a sheet.

### Description of the Related Art

In an image forming apparatus of an electrophotographic system, a latent image formed on an image bearing member of an image forming portion is developed to be visualized. The visualized image is transferred on a sheet fed to the image forming portion. Then, the transferred image is fixed with heat and pressure in a fixing device. As a result, an image is formed on the sheet. The sheet on which an image has been fixed in the fixing device is discharged outside the apparatus by a discharge roller.

Japanese Patent Application Laid-Open No. 2018-200437 discloses an image forming apparatus wherein when a duplex printing is performed on a sheet, a sheet on one surface of which an image has been formed via the fixing device is reversely conveyed by a reverse roller to an image forming portion again via a duplex conveying path. Then, by the processes of transfer and fixation, an image is formed on the other surface of the sheet. The sheet on both surfaces of which an image has been formed is discharged outside the apparatus by a discharge roller.

However, in the image forming apparatus disclosed in Japanese Patent Application Laid-Open No. 2018-200437, when a duplex printing is performed, the reverse roller is normally rotated to convey a sheet towards outside the apparatus for a constant distance and thereafter is reversely rotated to convey the sheet through the duplex conveying path.

### SUMMARY OF THE INVENTION

The object of the present invention is to provide an image forming apparatus that can suppress the shift in the axial direction of the reverse roller between the cases of normal rotation and reverse rotation.

A representative configuration of an image forming apparatus comprising:
an image forming portion configured to form an image on a sheet;
a re-feeding portion configured to feed again the sheet on which an image has been formed by the image forming portion to the image forming portion; and
a reverse portion configured to reverse the sheet on which an image has been formed by the image forming portion and to convey the reversed sheet to the re-feeding portion,
wherein the reverse portion includes:
a reverse roller configured to convey the sheet while rotating normally and thereafter to convey the the sheet by reversing the direction of the conveying of the sheet while rotating reversely;
a helical gear provided on a shaft of the reverse roller, the helical gear being configured to rotate together with the reverse roller to transmit a driving force to the reverse roller; and
a pressing member configured to press the reverse roller in an axial direction.

Further features of the present invention will become apparent from the following description of exemplary embodiments with reference to the attached drawings.

### BRIEF DESCRIPTION OF THE DRAWINGS

FIG. 1 is a diagram showing a cross-sectional view of an image forming apparatus.

FIG. 2 is a diagram showing a plan view of a reverse roller during normal rotation.

FIG. 3 is a diagram showing a plan view of the reverse roller during reverse rotation.

FIG. 4 is a diagram showing a plan view of the reverse roller.

FIG. 5 is a diagram showing a plan view of the reverse roller.

FIG. 6 is a diagram showing a plan view of the reverse roller.

FIGS. 7A, 7B and 7C are diagrams showing a perspective view of the reverse roller.

### DESCRIPTION OF THE EMBODIMENTS

Hereinafter, with reference to the drawings, a preferred embodiment of the present invention will be exemplarily described in detail. However, the dimensions, materials, shapes and relative positions of the components of the image forming apparatus described in the following embodiment should be varied as appropriate according to the configuration of an apparatus to which the present invention is applied and the various conditions, and the following description is not intended to limit the scope of the invention only to them.

### Image Forming Apparatus

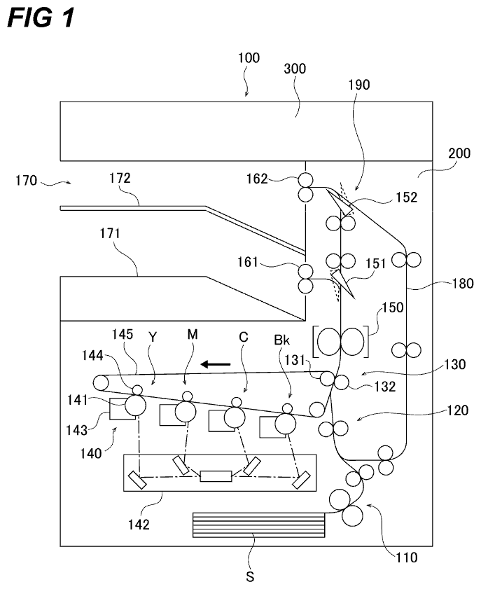

The image forming apparatus according to an embodiment of the present invention will be described with reference to FIG. 1. FIG. 1 is a schematic diagram showing a cross-sectional view of the image forming apparatus. The image forming apparatus 100 shown in FIG. 1 is exemplified as an image forming apparatus of intermediate transfer tandem system wherein four image forming portions 140 for four colors are disposed side by side on the intermediate transfer belt 145.

The image forming apparatus 100 is provided with the image forming portions 140, the re-feeding portion 180 that feeds the sheet S on which an image has been formed by the image forming portions 140 to the image forming portions 140 again, and the reverse portion 190 that reverses the sheet S on which an image has been formed by the image forming portions 140 and conveys it to the re-feeding portion 180.

The sheets S are stacked and accommodated in a accommodating portion such as a cassette disposed at a lower portion of the image forming apparatus. The sheet S accommodated in the accommodating portion are fed by the sheet feeding portion 110 in synchronism with the image formation of the image forming apparatus. The sheet S fed by the sheet feeding portion 110 is conveyed to the skew feeding correction device 120. The sheet S is conveyed to the secondary transfer portion 130 after the skew feeding correction and the timing correction are performed for the sheet S by the skew feeding correction device 120. The secondary transfer portion 130 is constituted by the secondary transfer inner roller 131 and the secondary transfer outer roller 132, which are opposed to each other via the intermediate transfer belt 145. The secondary transfer portion 130 transfers a toner image formed on the intermediate transfer belt 145 onto the sheet S by applying a predetermined pressure and an electrostatic load bias to the sheet S while nipping and conveying the sheet S.

Next, a description will be made to the process of forming an image which is sent to the secondary transfer portion 130 at the same time where the sheet S is conveyed to the secondary transfer portion 130 by the conveying process described above. The image forming portion 140 is mainly constituted of the photosensitive body 141, the exposure device 142, the developing device 143, the primary transfer device 144. The surface of the photosensitive body 141 has been previously uniformly charged by a charging portion (not shown). An electrostatic latent image is formed on the charged photosensitive body 141 by the exposure device 142 emitting light according to an image information signal, which reaches the photosensitive body 141 via diffraction units as appropriate. The electrostatic latent image that has been formed on the photosensitive body 141 in this way is developed by the developing device 143, so that a toner image is formed on the photosensitive body 141. The toner image formed on the photosensitive body 141 is given a predetermined pressure and an electrostatic load bias by the primary transfer device 144 at the primary transfer portion where the photosensitive body 141 and the primary transfer device 144 are opposed to each other and the toner image is transferred on the intermediate transfer belt 145.

The image forming portions 140 of the image forming apparatus shown in FIG. 1 are provided for the four colors yellow Y, magenta M, cyan C, and black Bk. The image forming portions 140 for four colors are disposed side by side on the intermediate transfer belt 145.

Next, the intermediate transfer belt 145 will be described. The intermediate transfer belt 145 is wound around a plurality of rollers and is driven to rotate in the direction indicated by an arrow in FIG. 1. Accordingly, parallel processing is performed by the image forming portions 140 for the four colors yellow Y, magenta M, cyan C, and black Bk. The image forming processes for respective colors are performed in the primary transfer portions of the image forming portions 140 at times when a toner image is superimposed on the upstream toner images primarily transferred on the intermediate transfer belt 145. As a result, a full-color toner image is finally formed on the intermediate transfer belt 145, which is then conveyed to the secondary transfer portion 130.

By the above process of conveying the sheet S and the above process of forming an image, a full-color toner image is secondarily transferred on the sheet S at the secondary transfer portion 130. Thereafter, the sheet S is conveyed to the fixing device 150. The fixing device 150 fixes the toner image on the sheet S by applying a predetermined pressure with opposed rollers or belts and by adding heating effect on the sheet S caused generally by a heat source such as a heater.

The sheet S with the fixed image obtained in this way is guided towards the first discharge roller 161 by the first switching flapper 151 in the position indicated by the solid line in FIG. 1 and discharged on the first stacking portion 171 by the first discharge roller 161. Alternatively, the sheet S is guided upwardly by the first switching flapper 151 switched in the position indicated by the broken line in FIG. 1 and is conveyed towards the second discharge roller 162.

The sheet S conveyed towards the second discharge roller 162 is guided towards the second discharge roller 162 by the second switching flapper 152 in the position indicated by the broken line in FIG. 1 and is discharged on the second stacking portion 172 disposed over the first stacking portion 171 by the second discharge roller 162.

In the case of duplex printing, after the backend of the sheet S passes through the second switching flapper 152, the second discharge roller 162 is reversely rotated. In this reverse operation of the second discharge roller 162, the sheet S is guided towards the re-feeding portion 180 by the second switching flapper 152 switched in the position indicated by the solid line in the FIG. 1. Namely, in the case of duplex printing, the sheet S on which an image has been formed by the image forming portions 140 is reversely conveyed by the reverse portion 190 to the re-feeding portion 180 and is conveyed again to the image forming portions 140 by the re-feeding portion 180.

Then, the sheet S is conveyed via the re-feeding portion 180 and is further conveyed by the skew-feeding correction device 120 to the image forming portions 140 (second transfer portion 130) where an image is formed on the second surface in the same way as on the first surface. The sheet S on the first and second surfaces of which images are formed is discharged on the first stacking portion 171 or on the second stacking portion 172.

The first stacking portion 171 and the second stacking portion 172 on which discharged sheets S are stacked have an inclined surface that ascends from upstream to downstream in the discharge direction of the sheet S. Accordingly, the discharged sheets S can be aligned with the upstream side in the discharging direction due to their own weights of the sheets S.

### Reverse Portion

Next, the reverse portion 190 will be described in detail. The reverse portion 190 has a reverse roller (second discharge roller 162) that conveys the sheet in normal rotation or in reverse rotation, and the second switching flapper 152 as a switching member.

In the present embodiment, the second discharge roller 162 that discharges the sheet S outside the apparatus also serves as the reverse roller. However, the present invention is not limited to this configuration. Separately from the discharge roller that discharges the sheet outside the apparatus, a reverse roller may be independently provided.

The image forming apparatus shown in FIG. 1 is provided with the image reading portion 300 that reads an image on a document above the image forming portions 140 via the space 170 formed inside the apparatus. The first stacking portion 171 and the second stacking portion 172 are disposed in the space 170 formed between the image forming portions 140 and the image reading portion 300. The second discharge roller 162 that discharges the sheet on which an image has been formed onto the second stacking portion 172 serves as the reverse roller.

The second switching flapper 152 is provided between the image forming portions 140 and the second discharge roller 162 as a reverse roller. The second switching flapper 152 is a switching member that is switched in the first position and the second position that is different from the first position. In the present embodiment, the first position (indicated by the broken line in FIG. 1) is for guiding the sheet on which an image has been formed by the image forming portions 140 and the second position (indicated by the solid line in FIG. 1) is for guiding the sheet S that is reversely conveyed by the second discharge roller 162 as the reverse roller is guided to the re-feeding portion 180.

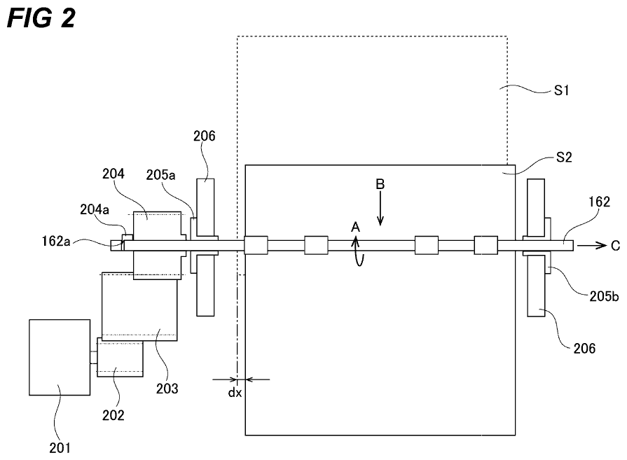

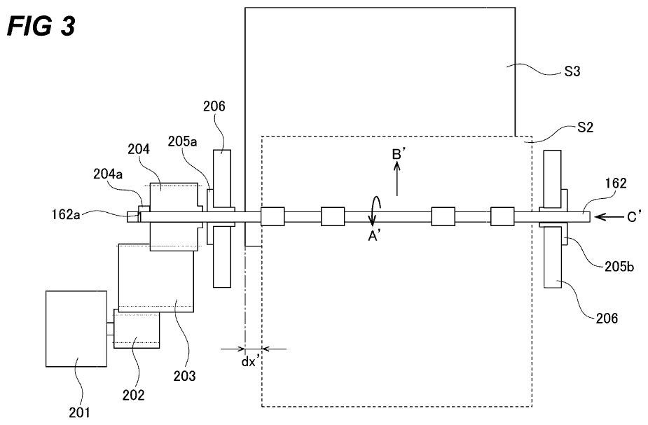

The second discharge roller 162 as the reverse roller receives a driving force from the motor 201 as a driving force to normally rotate or to reversely rotate. The second discharge roller 161 will be described in detail with reference to FIGS. 2 and 3. FIGS. 2 and 3 are diagrams showing the vicinity of the second discharge roller 162 of the image forming apparatus 100. FIG. 2 is a diagram showing how the sheet S is conveyed by the second discharge roller 162 before the sheet S is reversed. FIG. 3 is a diagram showing how the sheet S is conveyed by the second discharge roller 162 after the sheet S has been reversed.

As shown in FIGS. 2 and 3, the second discharge roller 162 has the driving gear 204. The driving gear 204 is provided on one end portion of the shaft of the second discharge roller 162. The driving gear 204 engages with the second discharge roller 162 in the rotational direction, so that the driving gear 204 and the second discharge roller 162 rotate simultaneously. The driving gear 204 is provided with the engaging portion 204a and the second discharge roller 162 is provided with the roller groove 162a to engage with the engaging portion 204a in the thrust direction. Namely, the engaging portion 204a of the driving gear 204 engages with the the roller groove 162a of the second discharge roller 162 in the thrust direction, so that the second discharge roller 162 moves in synchronism with the driving gear 204 in thrust direction.

The motor gear 202 connected to the motor 201 engages with the gear 203 and the gear 203 engages with the driving gear 204 of the second discharge roller 162. With this configuration, the motive power of the motor 201 transmits via the gear 202, the gear 203, and the gear 204 in this order. Upon receiving the driving force of the motor 201, the second discharge roller 162 rotates normally or reversely.

The driving gear 204 of the second discharge roller 162 is a helical gear. The helical driving gear 204 is provided on the shaft of the second discharge roller 162, so that the helical driving gear 204 normally or reversely rotates integrally with the second discharge roller 162. Therefore, as shown in FIG. 2, the thrust force effects on the second discharge roller 162 that normally rotates between the driving gear 204 that normally rotates and the gear 203 in the direction indicated by the arrow C that is directed from one end side to the other end side of the axial direction. In contrast, as shown in FIG. 3, the thrust force effects on the second discharge roller 162 that reversely rotates between the driving gear 204 that reversely rotates and the gear 203 in the direction indicated by the arrow C′ that is directed from the other end side to the one end side of the axial direction.

In the above description, the driving gear 204 is exemplified as a helical gear that produces a thrust force that effects on the normally rotating roller in the direction indicated by the arrow C and produces a thrust force that effects on the reversely rotating roller in the direction indicated by the arrow C′. However, the present invention is not limited to this configuration. Depending on the inclination of the gear tooth of the helical gear with respect to the rotational direction, the direction of the thrust force that effects on the roller may be opposite.

Next, the case where the second discharge roller 162 rotates in the direction indicated by the arrow A and the sheet S is conveyed in the direction indicated by the arrow B will be described. The second discharge roller 162 normally rotates in the direction indicated by the arrow A and the conveys the sheet S in the direction indicated by the arrow B towards outside the apparatus, and stops when the backend of the sheet S passes through the second switching flapper 152. In this case, the sheet S is conveyed from the broken-line position S1 to the solid-line position S2 where it stops.

The direction and the strength of the thrust force that effects on the second discharge roller 162 may be different depending on the configuration of the gears and the shape of the conveyed sheet S. In the following, it is assumed that a thrust force effects on the second discharge roller 162 in the direction indicated by the arrow C when the second discharge roller 162 normally rotates in the direction indicated by the arrow A. When the second discharge roller 162 moves in the axial direction for the distance dx due to the thrust force C, the sheet S also moves in the axial direction for the distance dx while being conveyed in the direction indicated by the arrow B.

Next, the case where the second discharge roller 162 rotates in the direction indicated by the arrow A′ that is opposite to the arrow A and the sheet S is conveyed in the direction indicated by the arrow B′ that is opposite to the arrow B will be described. The second discharge roller 162 reversely rotates in the direction indicated by the arrow A′ and the conveys the sheet S in the direction indicated by the arrow B′ towards the re-feeding portion 180. The sheet S is reversely conveyed from the broken-line position S2 in FIG. 3 that is the position where the sheet S is stopped (solid-line position in FIG. 2) to the solid-line position S3.

When the sheet is reversely conveyed, the thrust force C′ that is opposite to the thrust force C in FIG. 2 effects on the second discharge roller 162 because the direction of rotation of the second discharge roller 162 is opposite and the conveying direction of the sheet S is opposite. When the second discharge roller 162 moves in the axial direction for the distance dx′ due to the thrust force C′ during the reverse conveyance of the sheet S, the sheet S also moves in the axial direction for the distance dx′ while being conveyed in the direction indicated by the arrow B′. When the moving amount dx of the sheet S to one side in the axial direction in FIG. 2 is not equal to the moving amount dx′ of the sheet S to the other side in the axial direction in FIG. 3, the sheet S shifts in the direction perpendicular to the conveying direction for the difference (y=dx′−dx) during the reverse conveyance of the sheet S. The reversely conveyed sheet S is re-fed to the image forming portions 140 where printing is performed on the second surface. In this case, the image on the second surface shifts in position to the image on the first surface for difference (y=dx′−dx) in the axial direction. When this image shift of the difference y occurs, quality of the printed product could be degraded. In other words, due to reactive forces of the sheet and a gear, a force is applied to the reverse roller for moving it in the axial direction (thrust direction) perpendicular to the sheet conveying direction, so that the thrust positions of the reverse roller changes between the cases of normal rotation and reverse rotation. By the difference in the moving amount in the thrust direction of the reverse roller between the cases of normal rotation and reverse rotation causes the relative positional shift in the main scanning direction between on the first surface and on the second surface of the sheet, leading to degradation of the print product.

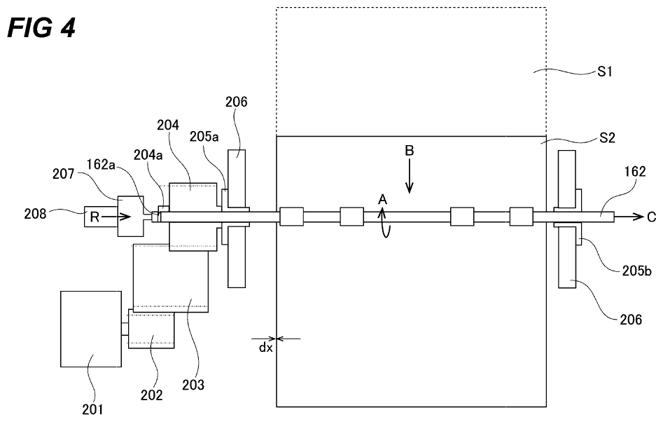

In view of this, as shown in FIG. 4, the second discharge roller 162 is pressed by the pressing member 207 in the axial direction (thrust direction). Namely, the reverse portion 190 has the pressing member 207 that presses the second discharge roller 162 as a reverse roller in the axial direction. FIG. 4 is a diagram showing a top view of the second discharge roller 162 as a reverse roller.

The pressing member 207 abuts on the one end portion of the shaft of the second discharge roller 162 as a reverse roller and presses the second discharge roller 162 from the one end side to the other end side in the axial direction. In the present embodiment, the pressing member 207 is exemplified as a pressing member that is pressed from the one side to the other side in the axial direction by the urging member 208 such as a coil spring as shown in FIG. 4. However, the configuration of the pressing member is not limited to this configuration.

The second discharge roller 162 is rotatably supported by the bearings 205a and 205b that are located at both sides in the axial direction outside the the conveying area of the sheet S in which a roller portion that is contact with the sheet S is disposed. The bearings 205a and 205b are attached to the guide member 206 that is a supporting member that supports the second discharge roller 162.

The pressing member 207 that presses the second discharge roller 162 in the axial direction (thrust direction) is configured such that the pressing force R in the axial direction is greater than the thrust force C. Namely, the the pressing force R of the pressing member 207 is set to be greater than the moving force (thrust force C) effected on the second discharge roller 162 in the axial direction during normal rotation of the second discharge roller 162. With this pressing force R, the driving gear 204 abuts against the bearing 205a, so that the movement of the second discharge roller 162 in the axial direction is restricted and the the second discharge roller 162 is positioned in the thrust direction.

The second discharge roller 162 as a reverse roller has an abutting member that abuts against the guide member 206 (bearing 205a) by the pressing force R of the pressing member 207. In the configuration shown in FIG. 4, the driving gear 204 provided on one end portion of the shaft of the second discharge roller 162 serves as the abutting member that abuts against the guide member 206 (bearing 205a) as a supporting member.

Further, as shown in FIG. 4, the driving gear 204 as an abutting member abuts against the bearing 205a as a supporting member that supports the second discharge roller 162 as a reverse roller by the pressing force of the pressing member 207, so that the movement of the second discharge roller 162 in the axial direction is restricted and the second discharge roller 162 is positioned in the axial direction. The bearing 205a is provided on the guide member 206 as a supporting member that supports the second discharge roller 162 to rotatably support the shaft of the second discharge roller 162. The guide member 206 as a supporting member and the bearing 205a provided on the guide member 206 do not move in the axial direction. Therefore, the second discharge roller 162 as a reverse roller is positioned in the axial direction by the driving gear 204 as an abutting member abuts against the bearing 205a as a supporting member by the pressing force of the pressing member 207.

As shown in FIG. 4, even if with the driving gear 204 abutted on the bearing 205a, the second discharge roller 162 normally rotates in the direction indicated by the arrow A to convey the sheet S in the direction indicated by the arrow B, the movement of the second discharge roller 162 in the axial direction is restricted. Accordingly, the moving amount dx of the second discharge roller 162 in the axial direction during the conveyance of sheet S in the direction indicated by the arrow B becomes zero and the moving amount (shift amount) of the sheet S in the axial direction also becomes zero.

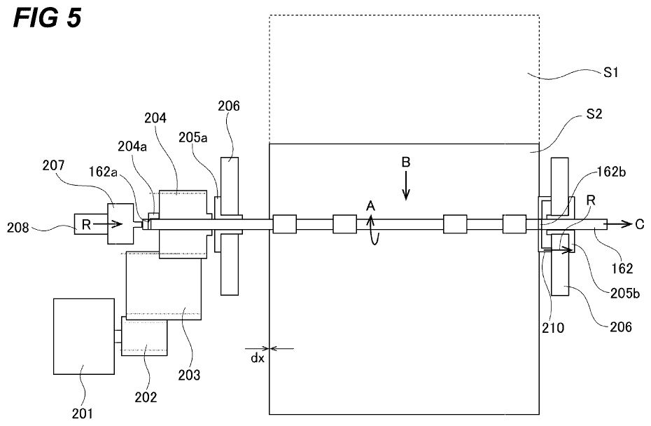

The configuration of the abutting member is not limited to the one shown in FIG. 4 and for example, the abutting member may be configured as shown in FIG. 5.

As shown in FIG. 5, the second discharge roller 162 as a reverse roller may be configured to have the engaging member 210 as an abutting member separately with the driving gear 204. The roller groove 162b is provided on the second discharge roller 162 that engages the engaging member 210 in the thrust direction. Namely, the engaging member 210 engages in the thrust direction with the roller groove 162b of the second discharge roller 162, so that the engaging member 210 and the second discharge roller 162 move in the thrust direction in conjunction with each other. The engaging member 210 is provided on the other end side of the shaft of the second discharge roller 162. The engaging member 210 is abutted against the guide member 206 as a supporting member by the pressing force of the pressing member 207 and engages with the guide member 206 in the axial direction.

As shown in FIG. 5, the engaging member 210 as an abutting member is abutted against the guide member 206 as a supporting member that supports the second discharge roller 162 as a reverse roller by the pressing force of the pressing member 207, so that the movement of the second discharge roller 162 in the axial direction is restricted and the second discharge roller 162 is positioned in the axial direction. As described above, as long as the engaging member 210 that engages with the second discharge roller 162 in the thrust direction abuts against the guide member 206, it is not necessary for the driving gear 204 to abut against the bearing 205a.

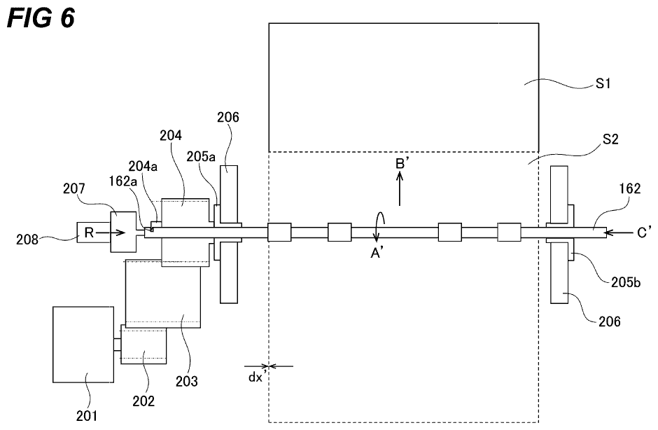

Next, the case will be described where the second discharge roller 162 rotates in the direction indicated by the arrow A′ and the sheet S is reversely conveyed in the direction identified by the arrow B′ with reference to FIG. 6. FIG. 6 is a diagram showing a top view of the second discharge roller 162 as a reverse roller.

The second discharge roller 162 is pressed by the pressing member 207 in the axial direction (thrust direction) similar to the case shown in FIG. 4. The pressing member 207 that presses the second discharge roller 162 in the axial direction (thrust direction) is configured such that the pressing force R in the axial direction is greater than the thrust force C′ similar to the case shown in FIG. 4. Namely, the pressing force R of the pressing member 207 is set to be greater than the moving force (thrust force C′) that effects on the second discharge roller 162 in the axial direction during the reverse rotation of the second discharge roller 162. In the case shown in FIG. 6, the direction of the pressing force R of the pressing member 207 is opposite to the direction of the moving force (thrust force C′) that effects on the second discharge roller 162 in the axial direction.

As shown in FIG. 6, even if the second discharge roller 162 reversely rotates in the direction indicated by the arrow A′ to reversely convey the sheet S in the direction indicated by the arrow B′, the pressing force R is greater than the thrust force C′, so that the movement of the second discharge roller 162 in the axial direction is restricted and the second discharge roller 162 is positioned in the axial direction. Accordingly, the moving amount dx′ of the second discharge roller 162 in the axial direction during the reverse conveyance of the sheet S in the direction indicated by the arrow B′ becomes zero and the moving amount (shift amount) of the sheet S in the axial direction also becomes zero. With this configuration, even during duplex printing, the shift in the axial direction (thrust direction) between the first surface and the second surface of the sheet S is suppressed.

As described above, in the present embodiment, the shift in the axial direction between during normal rotation and during reverse rotation of the second discharge roller 162 as a reverse roller can be suppressed, so that the position shift of sheet S caused by the shift of the second discharge roller 162 in the axial direction can be reduced.

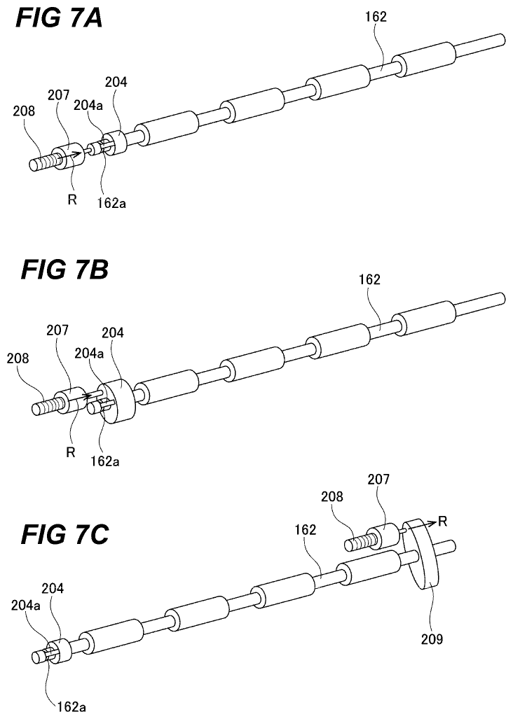

FIGS. 7A, 7B and 7C are diagrams showing perspective views of the second discharge roller as a reverse roller. Next, the pressing configuration of the second discharge roller 162 (reverse roller) using pressing member 207 will be described.

FIG. 7A is a diagram showing the pressing configuration of the reverse roller indicated in FIGS. 4 and 6. As shown in FIG. 7A, the pressing member 207 is urged by the urging member 208, so that the pressing member 207 presses the shaft end portion of the second discharge roller 162 as a reverse roller from one side to the other side in the axial direction. However, the pressing configuration of the reverse roller is not limited to this one. The pressing configuration of the reverse roller may be the one shown in FIG. 7B or the one shown in FIG. 7C.

In the case shown in FIG. 7B, the pressing member 207 presses the thrust end portion surface of the driving gear 204 from one side to the other side in the axial direction. In this way, the pressing member 207 exerts the pressing force R on the second discharge roller 162 as a reverse roller.

Alternatively, in the case shown in FIG. 7C, the second discharge roller 162 as a reverse roller is provided with the pressing force receiving member 209 at the other axial end portion that is opposite to the one axial end portion where the driving gear 204 is provided. The pressing member 207 presses the pressing force receiving member 209 from one side to the other side in the axial direction.

This configuration is adopted in the case where there is not enough space in the vicinity of driving gear 204 for providing the pressing member 207. In this case, the pressing force receiving member 209 is added that engages the second discharge roller 162 as a reverse roller and another pressing member 207 provided in the vicinity of the pressing force receiving member 209 presses the pressing force receiving member 209, to obtain the same effect.

The pressing member 207 is exemplified as to press the second discharge roller 162 as a reverse roller from one side to the other side in the axial direction but the configuration of the pressing member 207 is not limited to this one. The pressing member 207 may press the second discharge roller 162 as a reverse roller from the other side to the one side in the axial direction. With such configuration, the same effect can be obtained.

According to the present invention, the shift of the reverse roller between during the normal rotation and during the reverse rotation can be suppressed, so that the positional shift of the sheet caused by the shift of the reverse roller in the axial direction can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-048093, filed Mar. 25, 2024, which is hereby incorporated by reference herein in its entirety.

What is claimed is:

1. An image forming apparatus comprising:
an image forming portion configured to form an image on a sheet;
a re-feeding portion configured to feed again the sheet on which an image has been formed by the image forming portion to the image forming portion; and
a reverse portion configured to reverse the sheet on which an image has been formed by the image forming portion and to convey the reversed sheet to the re-feeding portion,
wherein the reverse portion includes:
a reverse roller configured to convey the sheet while rotating normally and thereafter to convey the the sheet by reversing the direction of the conveying of the sheet while rotating reversely;
a helical gear provided on a shaft of the reverse roller, the helical gear being configured to rotate together with the reverse roller to transmit a driving force to the reverse roller; and
a pressing member configured to press the reverse roller in an axial direction.

2. The image forming apparatus according to claim 1, further comprising:
a switching member provided between the image forming portion and the reverse roller, the switching member being configured to be switched to a first position where the switching member guides the sheet on which an image has been formed by the image forming portion to the reverse roller, and to a second position where the switching member guides the sheet that is reversed and conveyed by the reverse roller to the re-feeding portion.

3. The image forming apparatus according to claim 1,
wherein the reverse roller also functions as a discharge roller that discharges the sheet outside the image forming apparatus.

4. The image forming apparatus according to claim 1, further comprising:
an image reading portion provided above the image forming portion via a space in the image forming apparatus, the image reading portion being configured to read an image of a document;
a stacking portion provided in the space formed between the image forming portion and the image reading portion, the stacking portion being configured to stack the discharged sheet on which an image has been formed; and
a discharge roller configured to discharge the sheet on which an image is formed to the stacking portion,
wherein the reverse roller functions as the discharge roller.

5. The image forming apparatus according to claim 1,
wherein the reverse roller has an abutting member abutted by a pressing force of the pressing member.

6. The image forming apparatus according to claim 5,
wherein the helical gear functions as the abutting member.

7. The image forming apparatus according to claim 5,
wherein the abutting member is abutted by the pressing force of the pressing member against a supporting member configured to support the reverse roller, so that a movement of the reverse roller in the axial direction is restricted.

8. The image forming apparatus according to claim 7, further comprising:
a bearing configured to rotatably support the reverse roller,
wherein the abutting member is abutted against the supporting member by the pressing force of the pressing member via the bearing, so that a movement of the reverse roller in the axial direction is restricted.

9. The image forming apparatus according to claim 1,
wherein the pressing force of the pressing member is set to be greater than a moving force in the axial direction that effects on the reverse roller during rotation of the reverse roller.

10. The image forming apparatus according to claim 1,
wherein the pressing member is configured to press a shaft end portion of the reverse roller in the axial direction.

11. The image forming apparatus according to claim 1,
wherein the pressing member is configured to press a surface of a thrust end portion of the helical gear in the axial direction.

12. The image forming apparatus according to claim 1, further comprising:
a pressing force receiving member provided on one shaft end portion of the reverse roller opposite to the other end portion where the helical gear is provided,
wherein the pressing member is configured to press the pressing force receiving member in the axial direction.

13. The image forming apparatus according to claim 1,
wherein the pressing member includes a spring.
